(19) United States
(12) Patent Application Publication
(10) Pub. No.: US 2022/0258635 A1
(43) Pub. Date: Aug. 18, 2022

(54) Charging device for a traction battery

(71) Applicant: Webasto SE, Stockdorf (DE)

(72) Inventors: Waldemar Felde, Stockdorf (DE); Florian Koerfer, Stockdorf (DE)

(21) Appl. No.: 17/669,645

(22) Filed: Feb. 11, 2022

(30) Foreign Application Priority Data
Feb. 18, 2021 (DE) 102021103921.5

(51) Int. Cl. B60L 53/62; H02J 7/06; H02J 7/00

(52) U.S. Cl. CPC B60L 53/62; H02J 7/0031; H02J 7/06

(57) ABSTRACT

Charging device for charging and/or discharging an electrical energy store, which is preferably a traction battery for an electric or hybrid vehicle, wherein the charging device has: a main current path, which can be connected to a grid connection and the energy store, wherein the grid connection supplies an AC voltage; at least one relay, which is arranged in the main current path, has a make contact and is set up to interrupt the main current path in an open contact position and to close the main current path in a closed contact position; and a test apparatus which is electrically connected to the make contact of the relay and is set up to check the contact position of the relay; wherein the test apparatus comprises a zero crossing detection circuit, which is set up to detect the zero crossing of a phase at the make contact of the relay.

### CROSS-REFERENCE TO RELATED APPLICATION

This application claims priority to German Application No. DE 10 2021 103 921.5 filed Feb. 18, 2021, which is incorporated herein by reference in its entirety for all purposes.

### TECHNICAL FIELD

The present invention relates to a charging device for charging and/or discharging an electrical energy store, preferably a traction battery for an electric or hybrid vehicle, wherein the charging device has one or more relays in the main current path and a test apparatus for checking the relay contact positions.

### BACKGROUND

Battery systems for electric and hybrid vehicles are charged by means of external charging devices, for example by means of a wall box. The charging device serves as an interface between the power grid connected upstream and the vehicle. For this purpose, the charging device comprises relays in the main current path, by means of which charging device the charging power can be connected and disconnected. The relays also have a safety function in order to achieve reliable isolation of the vehicle from the power grid.

In the event of a malfunction, such as for example welding or carbonization of relay contact points, it is not possible to ensure proper control of the supply of power to the vehicle-side load. For safety reasons, the contact states of the relays are therefore monitored continuously in order to ensure that the contacts are actually open when they ought to be open and are closed when they ought to be closed.

One approach to solving the problem of checking or ensuring the intended relay contact states uses what are known as mirror contacts, which are formed by an additional contact pair in the relay. This additional contact pair is also moved when the main contacts are switched over, for example by means of a mechanical connection. The application of a test signal, for instance at GND or VCC potential, makes it possible to identify the position of the corresponding contact.

Alternative approaches to solving the problem use relays comprising make and break contacts, which may each be embodied as NC (normally closed) contacts or NO (normally open) contacts. A contact implemented as an NO contact is open when the relay is not excited. In an analogous manner, a contact implemented as an NC contact is closed when the relay is not excited. In order to check the contact states, the grid voltage from the main current path can be measured at the contact pairs and evaluated. As an alternative, it may suffice to measure the voltage only at the NO contacts. However, this procedure provides a plausible result only in particular power grid configurations, for example in what is known as split-phase operation, in which the voltages are opposite in phase (phase angle 180°) relative to the protective conductor. In other configurations, for instance in the case of single-phase operation (one of the phases is at the protective conductor potential) or in the case of a two-phase operation in a three-phase power grid, such a measurement is not readily possible.

High-power relays (over 40 A current carrying capacity) do not usually have mirror or NC contact pairs, with the result that this technology is not optimal for checking the relay contact states in the case of charging devices for traction batteries in vehicle construction. There is also the fact that the relays usually have to satisfy further normative requirements with respect to safety and durability. The few available relays of this power class often either do not satisfy the requirements or they are more structurally complex and thus more costly than standard components.

Other known solutions for relays without a mirror or NC contact only evaluate voltage levels at the NO contacts and for the aforementioned reasons are therefore unsuitable for carrying out plausibility checks in system configurations other than split-phase operation.

### SUMMARY OF THE INVENTION

It is an object of the present invention to provide an improved charging device for charging and/or discharging an electrical energy store, preferably a traction battery for an electric or hybrid vehicle.

The object is achieved by way of a charging device having the features of claim 1. Advantageous developments result from the dependent claims, the following description of the invention and the description of preferred exemplary embodiments.

The charging device according to the invention is used for charging and/or discharging an electrical energy store, which is preferably a traction battery for an electric or hybrid vehicle.

The charging device has a main current path, which can be connected to a grid connection and the energy store, wherein the grid connection supplies an AC voltage. The power is supplied from a usually standardized grid, such as the European or American power grid of the “single-phase three-wire” or “three-phase four-wire” type, via the grid connection. The charging device has at least one relay, which is arranged in the main current path, comprises a make contact and is set up to interrupt the main current path in an open contact position and to close the main current path in a closed contact position. There is an exchange of power between the grid connection and the energy store in the closed contact position. The one or more relays are preferably electromagnetically operating, remotely actuatable switches operated in a conventional manner by electric current and having the at least two mentioned switching positions.

The charging device further comprises a test apparatus, which is electrically connected to the make contact of the at least one relay and is set up to check the contact position of the relay. According to the invention, the test apparatus has a zero crossing detection circuit, which is set up to detect the zero crossing of a phase at the make contact of the relay in question. The contact position of the relay may be derived therefrom through monitoring of the make contact alone, for example by means of temporal averaging over one or more periods.

The test apparatus provides a cost-effective option that protects resources for ascertaining the contact states of one or more relays in the main current path of the charging device. Any microcontroller resources are protected since the contact testing can be carried out completely in the task system and therefore for example an interrupt (pin) is not necessary.

The test apparatus preferably comprises a microcontroller, and the zero crossing detection circuit preferably comprises a comparator which is electrically connected to the microcontroller, wherein the comparator is set up to generate a pulse signal from the phase applied to the make contact and to transmit same to the microcontroller. The pulse signal is a digital signal composed of “zeros” and “ones”, that is to say pulses at a HIGH potential and sections between the pulses at a LOW potential. A pulse is generated when the phase at the make contact exceeds a threshold value. By way of such “digitization” of the phase at the make contact, the contact testing can be simplified by way of the microcontroller, in particular the pulse signal can be further processed and the relay contact states can be derived in a manner supported by software.

The test apparatus is preferably set up to calculate an average value of the pulse signal over time. The switching state of the at least one relay can be directly derived therefrom, depending on whether the average value is essentially zero or has a positive absolute value.

The at least one relay is preferably designed as what is known as a closing contact, in which the make contact is an NO contact which is open when the relay is not excited and is otherwise closed. There is therefore a power exchange between the grid connection and the load, that is to say the energy store, only in the excited state of the relay. The aforementioned technical effects come in to play in particular in the case of such relays often designed for high currents that usually do not have mirror contacts and/or NC contacts. This facilitates the selection of appropriate relays for the charging device. Owing to the test apparatus described herein, there is no need for restriction to structurally complex and expensive products, as a result of which the test apparatus also improves the flexibility of the charging device.

The main current path preferably comprises a first line and a second line, which can be connected to the grid connection and the energy store, wherein the charging device in this case comprises a first relay, arranged in the first line, and a second relay, arranged in the second line. Each of the two relays has a make contact and is set up to interrupt the corresponding line in an open contact position and to close the corresponding line in a closed contact position. The test apparatus presented here is particularly suitable for detecting the contact positions of several relays together.

The references “first”, “second” in connection with relays, lines, microcontrollers, zero crossing detection circuits, pulse signals etc. serve purely for linguistic distinction; they do not imply any numbering, order, priority or the like.

For the aforementioned reasons, the two relays are preferably each designed as closing contacts, in which the corresponding make contact is an NO contact which is open when the relay is not excited and is otherwise closed. There is therefore a power exchange between the grid connection and the load, that is to say the energy store, only in the excited state of the relays.

The test apparatus preferably comprises a first zero crossing detection circuit and a second zero crossing detection circuit, which are correspondingly assigned to the first relay and the second relay, wherein the first zero crossing detection circuit is set up to detect the zero crossing of a phase at the make contact of the first relay and the second zero crossing detection circuit is set up to detect the zero crossing of a phase at the make contact of the second relay. The test apparatus thus provides a cost-effective option that protects resources for ascertaining the contact states of several relays in the main current path of the charging device. Any microcontroller resources are protected since the contact testing can be carried out completely in the task system and therefore for example an interrupt (pin) is not necessary. The analysed phases of several relays may furthermore be related to one another in order to ascertain further information about the contact states thereof and/or the grid configuration present at the grid connection.

The first zero crossing detection circuit preferably comprises a comparator which is electrically connected to the microcontroller, wherein the comparator of the first zero crossing detection circuit is set up to generate a first pulse signal from the phase applied to the make contact of the first relay and to transmit same to the microcontroller, wherein the first pulse signal has a pulse at a HIGH potential when the phase at the make contact of the first relay exceeds a threshold value and otherwise takes on a LOW potential. The second zero crossing detection circuit also preferably comprises a comparator which is electrically connected to the microcontroller, wherein the comparator of the second zero crossing detection circuit is set up to generate a second pulse signal from the phase applied to the make contact of the second relay and to transmit same to the microcontroller, wherein the second pulse signal has a pulse at a HIGH potential when the phase at the make contact of the second relay exceeds a threshold value and otherwise takes on a LOW potential. By way of such “digitization” of the phases at the corresponding relay make contacts, the contact testing can be simplified by way of the microcontroller, in particular the pulse signals can be further processed and the relay contact states can be derived in a manner supported by software.

Even if the present case discusses one microcontroller which processes both pulse signals, it is also possible for several microcontrollers to be used. By way of example, it is possible to install two microcontrollers which are correspondingly connected to the comparator of the first zero crossing detection circuit and the comparator of the second zero crossing detection circuit and are set up to evaluate the first pulse signal by way of the one microcontroller and the second pulse signal by way of the other microcontroller. Said two microcontrollers are to be distinguished from the first and second microcontrollers of the test pulse detection circuit that are described further below.

The test apparatus is preferably set up to calculate an XOR signal from an exclusive-or link of the first pulse signal and the second pulse signal, as a result of which a phase relationship between those phases on which the two pulse signals are based at the corresponding make contacts of the first and second relay and thus a switching state of the relays can be derived. The XOR signal is preferably calculated by the microcontroller based on software. However, the calculation can also take place by means of exclusive-or gates, that is to say based on hardware.

In the case of pulse signals with the same phase, the XOR always provides LOW. In the case of pulse signals with opposing phases, the XOR always provides HIGH. All other phase positions produce a change from LOW and HIGH which can be evaluated for example by means of an average value over time as described below. A possible superposition of the pulses that are generated by the comparators, in particular in a three-phase power grid, therefore plays no role in the evaluation using the XOR function.

The test apparatus is preferably set up to calculate an average value of the first pulse signal over time and an average value of the second pulse signal over time. One or more switching states of the relays can be derived directly therefrom. For even if the sampling of the signals takes place asynchronously, that is to say it is not possible to define how the potentials LOW and HIGH alternate specifically, the ratio between LOW and HIGH remains the same, however. Said ratio may be ascertained by means of an average value of the corresponding pulse signal. An average value of 0.5 corresponds in this case for example to a ratio of 1:1. The ratio is dependent only on the threshold values of the pulse-generating circuit.

The test apparatus preferably comprises a test pulse detection circuit, which is set up to ascertain the contact state of the first or second relay when the corresponding first or second line is a neutral conductor, that is to say does not carry any phase but for example carries the GND potential. The test pulse detection circuit permits contact position testing in single-phase operation, in which no phase is applied to the first or second line.

The test pulse detection circuit preferably comprises: a transistor, preferably designed as an NMOS; a resistor connected to the transistor; a first microcontroller, which is set up to control the gate terminal of the transistor; and a second microcontroller, which is set up to detect the voltage drop at the resistor. The first microcontroller is in this case set up to generate a test pulse at predetermined times, in particular at regular time intervals, wherein in this case the transistor opens and a voltage drops across the resistor, which voltage drop can be evaluated by the second microcontroller in order to ascertain the contact state of the corresponding relay.

The voltage value measured by the second microcontroller will turn out different depending on whether the make contact of the corresponding relay has a high impedance (that is to say the relay is open) or is at GND potential (that is to say the relay is closed). In this way, the test pulse detection circuit permits contact position checking in single-phase operation in a structurally simple and reliable manner. The test pulse detection circuit is preferably connected to the make contact of the second relay.

The test apparatus preferably comprises a phase amplitude detection circuit, which has a microcontroller and is set up to detect the phase amplitudes of the first and second line and to evaluate same by means of the microcontroller of the phase amplitude detection circuit. Here, the phase amplitude detection circuit is preferably set up to identify a single-phase operation at the grid connection when only one sinusoidal half-wave is ascertained within one period of the phase at the first or second line. In this way, the test apparatus can automatically distinguish between a case of single-phase operation and a case of two-phase operation of the grid connection in a structurally simple and reliable manner.

The test apparatus is preferably set up to identify a two-phase operation and single-phase operation at the grid connection. The test apparatus may also be set up in the event of a two-phase operation to differentiate between an operation with opposing phases and an operation with a phase shift that is unequal to 180°, preferably 120°. In this way, the charging device comprising a test apparatus according to the structure presented above can be used in different grid configurations in a particularly flexible manner.

Further advantages and features of the present invention are clear from the following description of preferred exemplary embodiments. The features described therein can be implemented alone or in combination with one or more of the features presented above, provided the features do not contradict one another. Preferred exemplary embodiments are described below in this case with reference to the accompanying drawings.

### BRIEF DESCRIPTION OF THE FIGURES

Preferred further embodiments of the invention are explained in more detail by way of the following description of the figures. In the figures:

FIG. 1 shows a schematic view of a charging device comprising relays in the main current path and a test apparatus for checking contact positions at the relays;

FIG. 2a shows a circuit diagram of a single-phase three-wire grid configuration;

FIG. 2b shows a circuit diagram of a three-phase four-wire grid configuration;

FIG. 3 shows a circuit diagram for a zero crossing detection circuit of the test apparatus for checking contact positions at the relays;

FIG. 4 shows a circuit diagram for determining the grid configuration by means of measuring the phase amplitude;

FIG. 5 shows a circuit diagram for checking contact positions at a relay in a neutral conductor;

FIG. 6 shows a circuit diagram for checking contact positions at a relay in a two-phase operation;

FIG. 7 shows a graph showing the phases and pulses generated by comparators for various relay states in a power grid with opposing phases; and

FIG. 8 shows a graph showing the phases and pulses generated by comparators for various relay states in a three-phase power grid.

### DETAILED DESCRIPTION OF PREFERRED EXEMPLARY EMBODIMENTS

Preferred exemplary embodiments are described below based on the figures. Here, elements that are identical, similar or have the same effect are provided with identical reference signs in the figures and a repeated description of these elements is partly omitted in order to prevent redundancy.

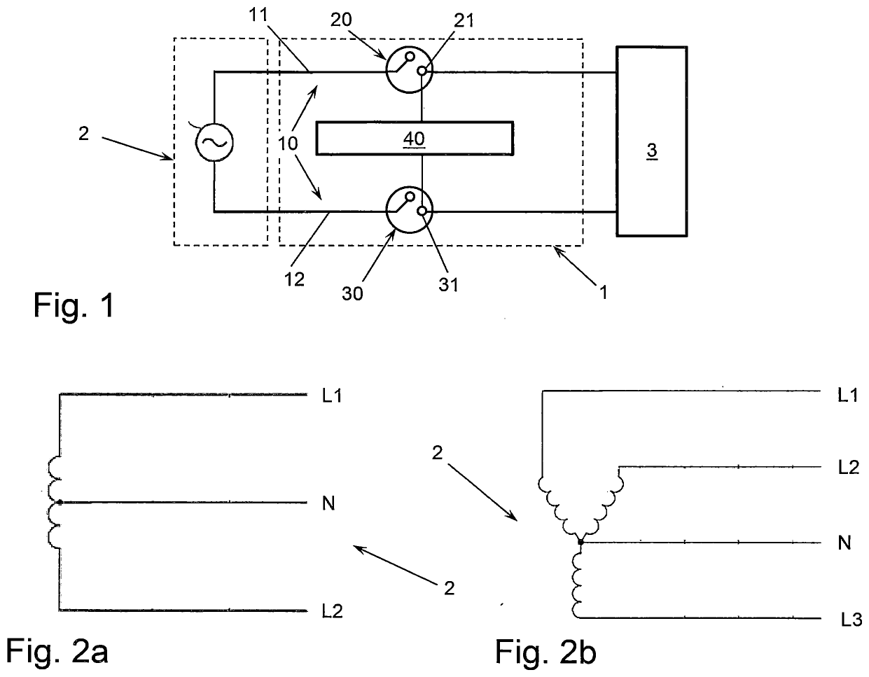

FIG. 1 is a schematic view of a charging device 1 comprising a first relay 20 and a second relay 30 in a main current path 10, which comprises a first line 11 and a second line 12, and a test apparatus 40 for checking contact positions at the relays 20, 30.

The charging device 1 functions as an interface between a schematically illustrated grid connection 2, which is connected upstream and provides an AC voltage, and a likewise schematically illustrated electrical energy store 3 which can be charged and/or discharged by means of the charging device 1. For this purpose, the charging device 1 is connected to the grid connection 2 such that the first and second line 11, 12 are each connected to one phase or the first line 11 is connected to one phase and the second line 12 is connected to the neutral conductor, if present. The energy store 3 is preferably a traction battery of an electric or hybrid vehicle.

The power is supplied from a usually standardized grid, such as the European or American power grid, via the grid connection 2, wherein the charging device 1 is preferably set up to be operated in various grid configurations in a flexible manner, in particular to be able to check the relay contact positions in various grid and connection configurations.

By way of example, two grid configurations that are conventional in North America and for which the charging device 1 may be set up are mentioned below. It should be noted that there is no restriction in this respect since the technical solutions described herein can also be applied to other grid configurations, for example for the European power grid.

FIG. 2a shows a grid configuration known by the designations “single-phase three-wire”, “Edison system”, “split-phase” and “centre-tapped-neutral”. Said grid configuration comprises two phase conductors L1 and L2, which conduct phases offset by 180°, and a neutral conductor N. The potential between L1 and N and L2 and N is 120 V, for example.

FIG. 2b shows a grid configuration known by the designation “three-phase four-wire” or “three-phase power grid”. Said grid configuration comprises three phase conductors L1, L2 and L3, which conduct phases offset by 120°, and a neutral conductor N. The voltage difference between each of the phase conductors L1, L2, L3 and the neutral conductor N is 230 V, for example.

If the charging device 1 is connected to one of these grid configurations mentioned by way of example, then a) either both lines 11, 12 are in contact with phase conductors L1, L2, L3, or b) one of the two lines 11, 12 is in contact with the neutral conductor N while the other line 11, 12 is in contact with one of the phase conductors L1, L2, L3. The case a) is referred to below as “two-phase operation” and the case b) is referred to as “single-phase operation”, wherein in order to simplify the description and without restriction it should be assumed in the following description that the neutral conductor N is connected to the second line 12. The case a) in turn comprises the cases a1), the phases are offset by 180° (cf. grid configuration of FIG. 2a), and a2), the phases are shifted by an absolute value other than 180°, for example by 120° (cf. three-phase power grid of FIG. 2b).

Returning to FIG. 1, the relays 20, 30 each comprise a make contact 21, 31, the voltage levels of which are evaluated by the test apparatus 40 for checking the contact states. The make contacts 21, 31 are preferably NO (normally open) contacts, that is to say the relays 20, 30, are preferably designed as a closing contact, in which the NO contact 21, 31 is open when the relay is not excited, thus interrupts the main current path 10 in the rest position. The test apparatus 40 is set up to cover at least one of the aforementioned cases, but preferably several thereof.

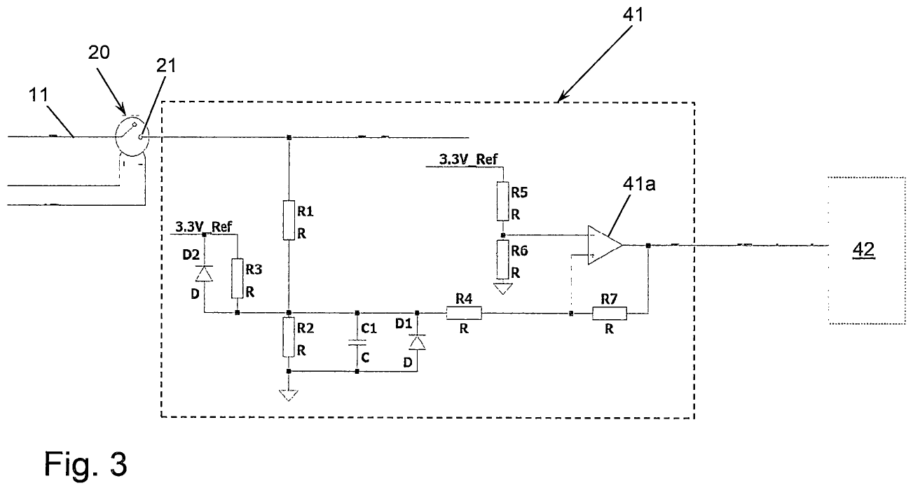

For this purpose, the test apparatus 40 may comprise a zero crossing detection circuit 41, cf. FIG. 3, with the aid of which a zero crossing of the phase at the corresponding make contact 21, 31 can be detected. For example, the centre point of a rising edge of a sinusoidal phase on the first line 11 and possibly the second line 12 (0 crossing point) can thus be detected by means of a microcontroller 42. The zero crossing detection circuit 41 may furthermore be set up to ascertain the grid frequency. Such a zero crossing detection circuit 41 is used both in single-phase operation and in two-phase operation.

FIG. 3 shows a possible embodiment of a zero crossing detection circuit 41 for the test apparatus 40. The zero crossing detection circuit 41 taps the phase for example at the make contact 21, said phase being converted into a digital pulse by a comparator 41a and thus being able to be evaluated by the microcontroller 42. If the phase at the make contact 21 of the corresponding relay 20 exceeds a threshold value, the comparator 41a generates a pulse so that a substantially square-wave pulse signal, which can take on one of two states, HIGH or LOW, is fed by the comparator 41a to the microcontroller 42.

In this way, for example the zero point of the phase on the line 11 and the grid frequency can be determined and evaluated after the digitization using software. However, it should be noted that digitization of the phase(s) is not necessarily required since the evaluation can also be carried out in principle in an analogous manner.

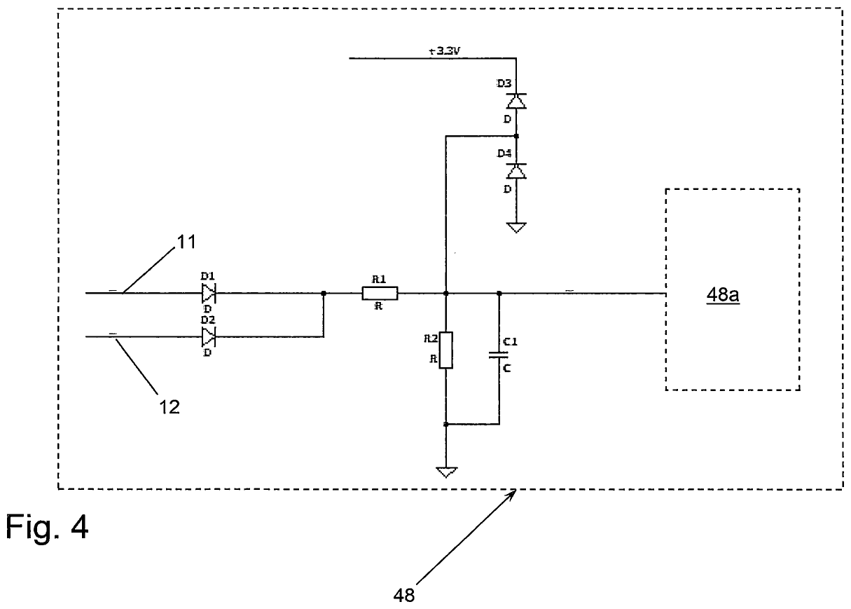

After the zero point of the phase on the line 11 and the grid frequency are known (0 crossing check), it is possible to measure the phase amplitude by means of the circuit according to a phase amplitude detection circuit 48 according to FIG. 4. The phase amplitude detection circuit 48 receives the phases of the lines 11 and 12 that are evaluated by a microcontroller 48a. If in the process only one sinusoidal half-wave is ascertained within the period, the grid configuration is identified as single-phase operation. However, the distinction between the case of single-phase operation and two-phase operation can also be made in another manner, for example by way of manual setting at the charging device 1.

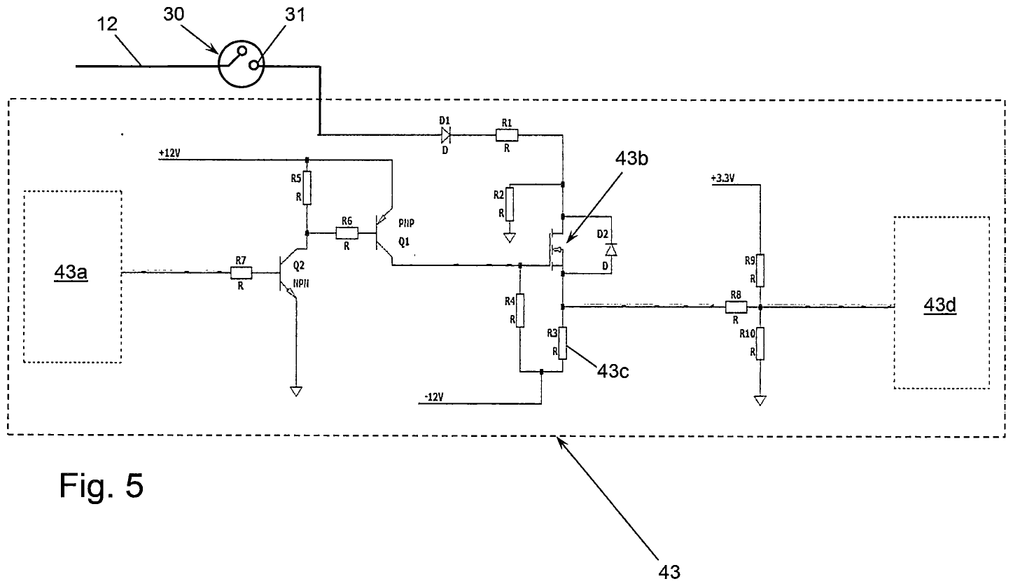

In single-phase operation, no phase is applied to the second line 12; instead, the line 12 in this case functions as neutral conductor. Phase measurement is therefore not possible. In order to ascertain the contact states of the corresponding relay 30, a test pulse detection circuit 43 according to FIG. 5 can be used.

The test pulse detection circuit 43 of FIG. 5 has a first microcontroller 43a, which controls the gate terminal of a transistor 43b, which is preferably an NMOS. The microcontroller 43a generates a short test pulse at predetermined times. In this case, the transistor 43b is opened and a voltage drop that can be evaluated by a second microcontroller 43d is produced across a resistor 43c.

The voltage value measured by the second microcontroller 43d will turn out different depending on whether the make contact 31 of the relay 30 has a high impedance (that is to say the relay 30 is open) or is at GND potential (that is to say the relay 30 is closed).

In contrast, the phase at the make contact 21 of the relay 20 of the first line 11 is measured by means of a comparator, for example according to the exemplary embodiment of FIG. 3 or as described below for the case of two-phase operation. A plausibility check is thus carried out to determine whether the measurement reflects the expected relay state. In the event of a fault, for example an optical fault notification can be output and the charging process is interrupted where necessary.

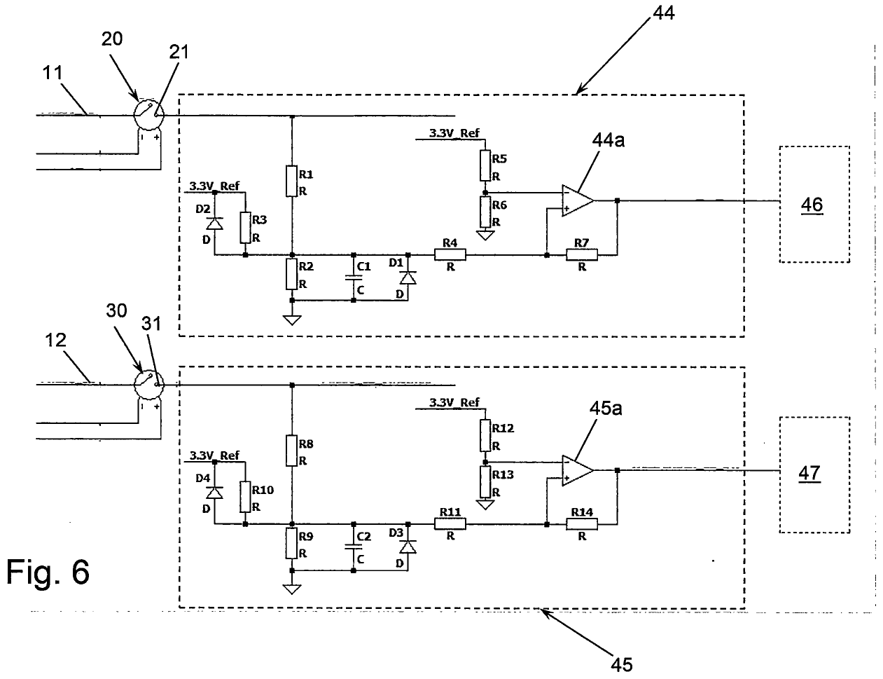

If a two-phase operation is determined, for example by means of a measurement of the phase amplitude according to the circuit of FIG. 4, the make contacts 21, 31 of the relays 20, 30 are evaluated by means of corresponding zero crossing detection circuits 44, 45 comprising respective comparators 44a, 45a and microcontrollers 46, 47, as shown in FIG. 6. It should be noted that the microcontrollers 46, 47 and the functionality thereof can also be implemented by way of a single microcontroller. In a manner analogous to the circuit of FIG. 3, the comparators 44a, 45a each generate a pulse at a potential HIGH when the phases at the make contacts 21, 31 of the corresponding relays 20, 30, which can be evaluated by the associated microcontrollers 46, 47 where necessary using suitable software, exceed a threshold value.

The zero crossing detection circuits 44, 45 according to FIG. 6 are not suitable for the case of single-phase operation since the phase at the make contact 31 of the second relay 30 either has a high impedance or is at GND potential, for which reason the comparator 45a in this case is never triggered and the output thereof remains at the potential LOW in all states of the relay 30.

Reference is made to the aforementioned case differentiation a1) and a2) for the further evaluation of the contact states of the relays 20, 30.

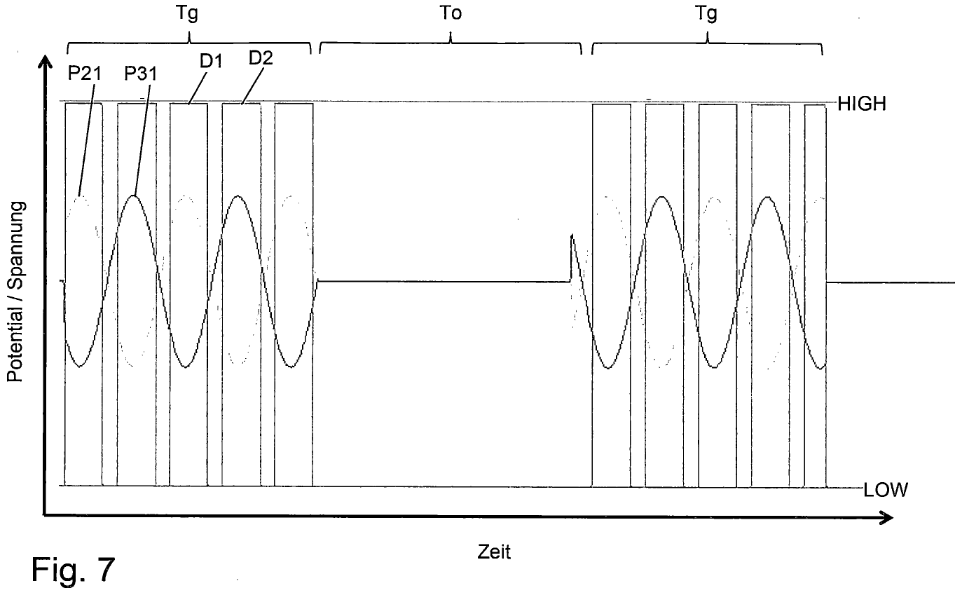

In the case of a phase shift of the lines 11 and 12 by 180°, as arises in a conventional power grid (split-phase operation), the phases are opposite. FIG. 7 is a graph that shows exemplary phases P21 and P31 at the make contacts 21, 31 of the corresponding relays 20, 30 for various relay states in an opposing-phase power grid as a function of time. According to this example, both relays 20, 30 are in the excited, closed state, that is to say the power is transmitted to the load, at the time intervals Tg and the relays 20, 30 are in the open state, in which the power supply is interrupted, at the time intervals To. The pulse signals D1, D2 generated by the comparators 44a, 45a are also marked in FIG. 7.

It is clear from FIG. 7 that the pulse signals D1, D2 generated by the comparators 44a, 45a are (temporarily) separated from one another, as a result of which they can easily be evaluated by the microcontrollers 46, 47, for example by way of individual average value formation.

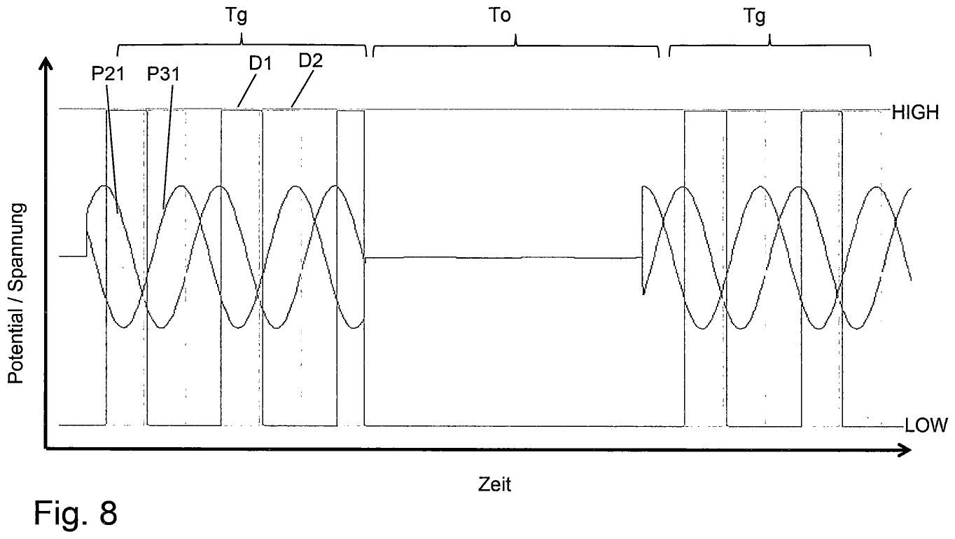

In a three-phase power grid, that is to say in a three-phase operation according to case a2), the evaluation is more complex since the individual phases are shifted by 120° with respect to one another and the pulses D1, D2 generated by the comparators 44a, 45 can therefore be superposed, as can be taken from FIG. 8.

FIG. 8, in a manner analogous to FIG. 7, is a graph that shows two exemplary phases P21 and P31 at the make contacts 21, 31 of the corresponding relays 20, 30 for various relay states in a three-phase power grid as a function of time. According to this example, both relays 20, 30 are in the excited, closed state, that is to say the power is transmitted to the load, at the time intervals Tg and the relays 20, 30 are in the open state, in which the power supply is interrupted, at the time intervals To. The pulse signals D1, D2 generated by the comparators 44a, 45a are also marked in FIG. 8.

It is clear from FIG. 8 that the pulse signals D1 and D2 are superposed in the time intervals Tg, wherein the following cases are to be distinguished for the evaluation of the phase angles: i) both relays 20, 30 are open; ii) both relays 20, 30 are closed; iii) one of the relays 20 or 30 is open, the other relay 20, 30 is closed, wherein the output thereof (make contacts 21, 31) are not connected; iv) one of the relays 20 or 30 is open, the other relay 20, 30 is closed, wherein the output thereof (make contacts 21, 31) are connected.

The evaluation of the cases can be carried out by the microcontrollers 46, 47 (or a joint microcontroller) using suitable software.

In case i), no pulse signals D1, D2 whose output potential is at LOW are generated by the comparators 44a, 45a. In case ii), pulse signals D1, D2 with pulses at HIGH potential are generated by both comparators 44a, 45a, according to the voltages upstream of the relays 20, 30 (in particular with respect to the phase position). In case iii), no pulse signals D1, D2 are generated by the comparator 44a or 45a of the open relay 20 or 30; the other comparator 44a or 45a that corresponds to the closed relay 20 or 30 generates pulse signals D1, D2 according to the applied phase. In case iv), the voltage of the closed relay 20 or 30 is applied to both relays 20, 30 in phase.

The first three cases i), ii) and iii) can easily be distinguished by virtue of the microcontroller 46, 47 checking whether pulses can be measured at both relays 20, 30. For this purpose, the pulse signals of both relays 20, 30 generated by the comparators 44a, 45a are sampled cyclically, preferably at a frequency greater than or equal to double the grid frequency. If the relay 20 is open, the associated pulse signal D1 will always be LOW; otherwise, it will alternate between LOW and HIGH. This applies accordingly to the second relay 30 and the associated pulse signal D2.

Since the sampling takes place in the simplest case in an asynchronous manner, it is not possible to define how the potentials LOW and HIGH alternate precisely. However, the ratio is fixed between LOW and HIGH, that is to say between the “zeros” and “ones”. Said ratio may be ascertained by means of an average value of the respective pulse signal D1, D2. An average value of 0.5 corresponds in this case to a ratio of 1:1. The ratio is dependent only on the threshold values of the pulse-generating circuit. If said circuit always optimally switches at a potential LOW of 0 V, the average value is 0.5, for example.

However, it is thus not possible to distinguish the fourth case iv) since pulses are generated for both relays 20, 30 and the pulse signals D1 and D2 accordingly indicate two closed relays 20, 30. The difference from case i) is the phase position between the pulses. If only one relay 20 or 30 is closed, the pulses are in phase; if both relays 20, 30 are closed, the phase position corresponds to the connected grid configuration, usually 180° or 120°.

In order to identify the phase position, the microcontrollers 46, 47 (where necessary comprising suitable software) are preferably set up to calculate an XOR signal as exclusive-or (Boolean function XOR) from D1 and D2. This calculation can also be carried out by means of an exclusive-or gate, that is to say purely based on hardware. In the case of pulse signals D1, D2 with the same phase, the XOR always provides LOW. In the case of pulse signals D1, D2 with opposing phases, the XOR always provides HIGH. All other phase positions produce a change from LOW and HIGH which can be evaluated by means of the average value over time as described above.

A possible superposition of the pulses generated by the comparators 44a, 45a no longer plays a role in the evaluation using the XOR function and all contact states according to cases i) to iv) can be clearly distinguished from one another.

The following table 1 summarizes the evaluation of the pulses D1, D2 generated by the comparators 44a, 45a for a grid configuration with a phase angle of 180°, wherein the HIGH potential is denoted by the value “1” and the LOW potential is denoted by the value “0”;

| | | Average | Average | Average value |
|---|---|---|---|---|
| Relay 20 | Relay 30 | value D1 | value D2 | D1 XOR D2 |
| Open | Open | 0 | 0 | 0 |
| Closed | Closed | 0.5 | 0.5 | 1 |
| Open | Closed | 0 | 0.5 | 0.5 |
| Open (connected | Closed | 0.5 | 0.5 | 0 |
| to relay 30) | | | | |

The embodiments of the test apparatus 40 for a charging device 1 presented above provide a cost-effective option that protects resources for ascertaining the contact states of relays 20, 30 in a main current path 10 of the charging device 1. This applies in particular for high-power relays 20, 30, which often do not have mirror contacts and/or NC contacts. This facilitates the selection of appropriate relays 20, 30 in the charging device 1. Microcontroller resources are protected since the contact testing can be carried out completely in the task system and therefore for example an interrupt (pin) is not necessary.

It should be noted that the electrical switching signs and their designations, voltages or potential differences specified in the circuit diagrams are purely exemplary. There is no restriction thereto since the functions presented above can be implemented both with other values and modified circuits.

If applicable, all individual features that are illustrated in the exemplary embodiments can be combined with one another and/or exchanged without departing from the scope of the invention.

### LIST OF REFERENCE SIGNS

1 Charging device
2 Grid connection
3 Electrical energy store
10 Main current path
11 First line
12 Second line
20 First relay
21 Make contact
30 Second relay
31 Make contact
40 Test apparatus
41 Zero crossing detection circuit
41a Comparator
42 Microcontroller
43 Test pulse detection circuit
43a First microcontroller
43b Transistor
43c Resistor
43d Second microcontroller
44 First zero crossing detection circuit
44a Comparator
45 Second zero crossing detection circuit
45a Comparator
46 Microcontroller
47 Microcontroller
48 Phase amplitude detection circuit
48a Microcontroller
L1 Phase conductor
L2 Phase conductor
L3 Phase conductor
N Neutral conductor
P21 Phase at the make contact 21
P31 Phase at the make contact 31
D1 First pulse signal
D2 Second pulse signal
Tg Time interval closed
To Time interval open

1. A Charging device for at least one of: charging and discharging an electrical energy store, wherein the charging device has:
a main current path, which is configured to be connected to a grid connection and the energy store, wherein the grid connection supplies an AC voltage;
at least one relay, which is arranged in the main current path, has a make contact and is set up to interrupt the main current path in an open contact position and to close the main current path in a closed contact position; and
a test apparatus which is electrically connected to the make contact of the relay and is set up to check the contact position of the relay; wherein the test apparatus comprises a zero crossing detection circuit, which is set up to detect the zero crossing of a phase at the make contact of the relay.

2. The Charging device according to claim 1, wherein the test apparatus comprises a microcontroller and the zero crossing detection circuit comprises a comparator which is electrically connected to the microcontroller, wherein the comparator is set up to generate a pulse signal from the phase applied to the make contact and to transmit same to the microcontroller, wherein the pulse signal has a pulse at a HIGH potential when the phase at the make contact exceeds a threshold value and otherwise takes on a LOW potential.

3. The Charging device according to claim 2, wherein the test apparatus is set up to calculate an average value of the pulse signal from which one or more switching states of the at least one relay is configured to be derived.

4. The Charging device according to claim 3, wherein the at least one relay is designed as a closing contact, in which the make contact is a NO contact which is open when the relay is not excited and is otherwise closed.

5. The Charging device according to claim 4, wherein the main current path comprises a first line and a second line, which is configured to be connected to the grid connection and the energy store, and the charging device comprises a first relay, arranged in the first line, and a second relay, arranged in the second line, wherein each of the two relays has a make contact and is set up to interrupt the corresponding line in an open contact position and to close the corresponding line in a closed contact position.

6. The Charging device according to claim 5, wherein the test apparatus comprises a first zero crossing detection circuit and a second zero crossing detection circuit, which are correspondingly assigned to the first relay and the second relay, wherein the first zero crossing detection circuit is set up to detect the zero crossing of a phase at the make contact of the first relay and the second zero crossing detection circuit is set up to detect the zero crossing of a phase at the make contact of the second relay.

7. The Charging device according to claim 6, wherein the first zero crossing detection circuit comprises a comparator which is electrically connected to the microcontroller, wherein the comparator of the first zero crossing detection circuit is set up to generate a first pulse signal from the phase applied to the make contact of the first relay and to transmit same to the microcontroller, wherein the first pulse signal has a pulse at a HIGH potential when the phase at the make contact of the first relay exceeds a threshold value and otherwise takes on a LOW potential, and
the second zero crossing detection circuit comprises a comparator which is electrically connected to the microcontroller, wherein the comparator of the second zero crossing detection circuit is set up to generate a second pulse signal from the phase applied to the make contact of the second relay and to transmit same to the microcontroller, wherein the second pulse signal has a pulse at a HIGH potential when the phase at the make contact of the second relay exceeds a threshold value and otherwise takes on a LOW potential.

8. The Charging device according to claim 7, wherein the test apparatus is set up to calculate an XOR signal from an exclusive-or link of the first pulse signal and the second pulse signal, as a result of which a phase relationship between those phases, on which the two pulse signals are based, at the corresponding make contacts of the first and second relay and thus a switching state of the relays is configured to be derived.

9. The Charging device according to claim 8, wherein the test apparatus is set up to calculate an average value of the first pulse signal over time and an average value of the second pulse signal over time, from which average values one or more switching states of the relays are configured to be derived.

10. The Charging device according to claim 9, wherein the test apparatus comprises a test pulse detection circuit, which is set up to ascertain the contact state of at least one of: the first relay and the second relay when at least one of: the corresponding first line and the second line is a neutral conductor.

11. The Charging device according to claim 10, wherein the test pulse detection circuit comprises: a transistor, preferably designed as an NMOS; a resistor connected to the transistor; a first microcontroller, which is set up to control the gate terminal of the transistor;
and a second microcontroller, which is set up to detect the voltage drop at the resistor; wherein
the first microcontroller is set up to generate a test pulse at predetermined times, wherein in this case the transistor opens and a voltage drops across the resistor, which voltage drop is configured to be evaluated by the second microcontroller in order to ascertain the contact state of the corresponding relay.

12. The Charging device according to claim 11, wherein the test pulse detection circuit is connected to the make contact of the second relay.

13. The Charging device according to claim 12, wherein the test apparatus comprises a phase amplitude detection circuit, which has a microcontroller and is set up to detect the phase amplitudes of the first and second lines and to evaluate same by means of the microcontroller of the phase amplitude detection circuit.

14. The Charging device according to claim 13, wherein the test apparatus is set up to identify a two-phase operation and a single-phase operation at the grid connection, wherein the test apparatus is set up in the event of a two-phase operation to differentiate between an operation with opposing phases and an operation with a phase shift that is unequal to 180°.

15. The Charging device according to claim 1, wherein the electrical energy store is a traction battery for at least one of: an electric vehicle and a hybrid vehicle.

16. The Charging device according to claim 5, wherein the relays are each designed as closing contacts, in which the corresponding make contact is a NO contact which is open when the relay is not excited and is otherwise closed.

17. The Charging device according to claim 7, wherein the microcontroller comprises two microcontrollers which are correspondingly connected to the comparator of the first zero crossing detection circuit and to the comparator of the second zero crossing detection circuit.

18. The Charging device according to claim 8, wherein the XOR signal is calculated by the microcontroller based on software.

19. The Charging device according to claim 11, wherein the predetermined times are at regular time intervals.

20. The Charging device according to claim 13, wherein the phase amplitude detection circuit is set up to identify a single-phase operation at the grid connection when only one sinusoidal half-wave is ascertained within one period of the phase at the first or second line.
